(19) United States
(12) Patent Application Publication
(10) Pub. No.: US 2013/0073320 A1
(43) Pub. Date: Mar. 21, 2013

(54) SYSTEM AND METHOD FOR COMPARING FINANCIAL INSTRUMENTS

(71) Applicant: Christopher D. DeLarme, Elburn, IL (US)

(72) Inventor: Christopher D. DeLarme, Elburn, IL (US)

(21) Appl. No.: 13/424,360

(22) Filed: Mar. 19, 2012

Related U.S. Application Data
(60) Provisional application No. 61/453,926, filed on Mar. 17, 2011.

(51) Int. Cl. G06Q 40/06; G06Q 40/08

(52) U.S. Cl. 705/4

(57) ABSTRACT

A method of providing a comparison of investments financial instruments includes the steps of: receiving, as an input, demographic information related to a person; receiving, as an input, information related to a life insurance policy; receiving, as an input, information related to one or more qualified plans; receiving, as an input, information related to one or more non-qualified investments; and providing, as an output, a graphic representation of a comparison of the value of the life insurance policy, the one or more qualified plans and the one or more non-qualified investments, wherein the graphic representation includes normalized values for the value of the life insurance policy, the one or more qualified plans, and the one or more non-qualified investments.

### CROSS-REFERENCE TO RELATED APPLICATIONS

This application claims the benefit of U.S. Provisional Application No. 61/453,926, filed on Mar. 17, 2011, the entirety of which is incorporated herein by reference.

### BACKGROUND OF THE INVENTION

The present subject matter relates generally to a system and method for comparing financial instruments. More specifically, the present invention relates to software designed to receive, as inputs, demographic information related to a person and investment information related to a life insurance policy, one or more qualified plans and one or more common financial instruments and provide, as an output, a normalized comparison of the life insurance, qualified plans and other common financial instruments based on the person's demographic information.

The purchase and sale of life insurance policies can be complicated as there are many factors that go into determining a policy price and value, particularly since life insurance policies can be used as investment vehicles and can be individualized. Choosing an insurance policy can often be daunting to policy owners specifically since comparing life insurance to other investment vehicles can be confusing.

Fairly comparing life insurance to other vehicles has always come with two main problems. The first problem is that life insurance is funded with after-tax dollars and many of the most popular retirement vehicles used by consumers (401 K's or other qualified accounts), are funded with pre-tax dollars. The second problem is number of factors needed to consider when comparing across various investment vehicles, for example, taxes, penalties, management fees and sale charges, etc.

Accordingly, a need exists for an automated system and method for collecting relevant information, producing normalized comparisons, and outputting results in a manageable and comprehensive format as described and claimed herein.

### BRIEF SUMMARY OF THE INVENTION

The Financial Instruments Comparison system was created to provide insurance and financial professionals an easy to use and efficient tool for comparing life insurance to qualified plans and other common financial instruments, including the comparison of the effects of taxes, penalties, management fees and sales charges where they apply. The Financial Instruments Comparison system allows the consumer and the advisor to accurately assess the most efficient funding vehicle for the consumer to use when planning for retirement.

The Financial Instruments Comparison system uses specific personalized parameters to make an analysis and provide an output. The personalization includes taking into account taxes, penalties, management fees and charges to provide a side-by-side comparison of life insurance policies to alternative investment vehicles. Not only does this save time for the professionals involved, creating more efficient reports in less time, but also it provides the consumer with a more organized way of seeing the information. This allows for the consumer to make a more informed decision.

The inputs for the Financial Instruments Comparison system include demographic information related to a person, investment information related to a life insurance policy, one or more qualified plans, and one or more common financial instruments. The Financial Instruments Comparison system then outputs a normalized comparison of the life insurance, qualified plans and other common financial instruments based on the person's demographic information.

In one example of the Financial Instruments Comparison system, after entering all of the required information into the Financial Instruments Comparison system, a chart is generated with values organized by the year and age of the consumer. It is understood that in some instances, the age of the consumer will be at or approaching zero, for example when planning investments for a young child. The values created are presented side by side including pre-tax accounts and after-tax accounts. In this example, the pre-tax column includes current use of money values including gross payment then gross withdrawal, and qualified plans and 401K net values. The after-tax section includes two columns. The first includes other investment options, which include net payment then net withdrawal, certificate of deposit net value, annuity net value, and stocks and bonds net value. The second column includes net payment then net withdrawal, living benefit life insurance including accumulation value, surrender (net) value, and death benefit. The organization and representations of the outputs allows a consumer to easily compare the different investment options and understand their choices of investment.

Along with the charts, the Financial Instruments Comparison system also creates an easy to read graph that illustrates the value of the different financial instruments over time. This is particularly useful to consumers because it allows them to see the values in direct comparison, so they can compare life insurance to other investment options.

In one example, a method of providing a comparison of investments financial instruments includes the steps of: receiving, as an input, demographic information related to a person; receiving, as an input, information related to a life insurance policy; receiving, as an input, information related to one or more qualified plans; receiving, as an input, information related to one or more non-qualified investments; and providing, as an output, a graphic representation of a comparison of the value of the life insurance policy, the one or more qualified plans and the one or more non-qualified investments, wherein the graphic representation includes normalized values for the value of the life insurance policy, the one or more qualified plans, and the one or more non-qualified investments. In a preferred embodiment the life insurance policy is a living benefit life insurance policy and the demographic information related to a person includes the person's age, an age at which distributions begin, the person's pre-retirement tax rate, the person's post-retirement tax rate, an annual rate of return for each investment, any fees associated with each investment, any premature distribution penalties associated with each investment, any sales charges associated with each investment, a capital gains tax rate, an annual contribution amount, and an annual withdrawal amount. The graphic representation may include an accumulation value, a surrender value, and a death benefit value for the living benefit life insurance.

The normalized value of the one or more qualified plans and the normalized value of the one or more non-qualified investments may be normalized for comparison to the living benefit life insurance policy. For example, the normalized value of a certificate of deposit may be determined as follows:

in years in which a contribution is made:

adding the value of the contribution to the value of the certificate of deposit;

reducing the value of the certificate of deposit by any sales charge;

growing the value of the certificate of deposit by the interest rate;

reducing the value of the certificate of deposit by any management fee; and

reducing the value of the certificate of deposit by a tax rate;

in years in which a withdrawal is made:

subtracting the value of the withdrawal from the value of the certificate of deposit;

growing the value of the certificate of deposit by the interest rate;

reducing the value of the certificate of deposit by any management fee; and

reducing the value of the certificate of deposit by a tax rate.

The normalized value of an annuity may be determined as follows:

in years in which a contribution is made:

reducing the value of the contribution by any sales charge;

adding the reduced value of the contribution to the value of the annuity;

growing the value of the annuity by the interest rate;

reducing the value of the annuity by any management fee;

reducing the value of the annuity by a tax rate; and

reducing the value of the annuity by any premature distribution penalty that applies;

in years in which a withdrawal is made:

subtracting a gross withdrawal value from the value of the annuity, wherein the gross withdrawal value is the gross value required to make a given net withdrawal;

growing the value of the annuity by the interest rate;

reducing the value of the annuity by any management fee; and

reducing the value of the annuity by a tax rate; and

reducing the value of the annuity by any premature distribution penalty that applies.

The normalized value of a stock or bond investment may be determined as follows:

in years in which a contribution is made:

reducing the value of the contribution by any sales charge;

adding the reduced value of the contribution to the value of the stock or bond investment;

growing the value of the stock or bond investment by the interest rate;

reducing the value of the stock or bond investment by any management fee;

and

reducing the value of the stock or bond investment by a tax rate;

in years in which a withdrawal is made:

subtracting the withdrawal from the value of the stock or bond investment;

growing the value of the stock or bond investment by the interest rate;

reducing the value of the stock or bond investment by any management fee;

and

reducing the value of the stock or bond investment by a tax rate.

The normalized value of a 401k or IRA investment may be determined as follows:

in years in which a contribution is made:

adding a gross contribution value to the value of the 401k or IRA investment, wherein the gross contribution value is the gross value required to equal a non-qualified contribution;

reducing the value of the 401k or IRA investment by any sales charge;

growing the value of the 401k or IRA investment by the interest rate;

reducing the value of the 401k or IRA investment by any management fee;

reducing the value of the 401k or IRA investment by a tax rate; and

reducing the value of the 401k or IRA investment by any premature distribution penalty that applies;

in years in which a withdrawal is made:

subtracting a gross withdrawal value from the value of the 401k or IRA investment, wherein the gross withdrawal value is the gross value required to make a given net withdrawal;

growing the value of the 401k or IRA investment by the interest rate;

reducing the value of the 401k or IRA investment by any management fee;

and

reducing the value of the 401k or IRA investment by a tax rate; and

reducing the value of the 401k or IRA investment by any premature distribution penalty that applies.

A graphic representation of a comparison between investments in a plurality of financial instruments may include: an annual normalized value for each of a life insurance policy, one or more qualified investments, and one or more non-qualified investments, wherein the life insurance policy is a living benefit life insurance policy, wherein the annual value for each of the one or more qualified investments and one or more non-qualified investments are normalized to compare with the living benefit life insurance policy, further wherein the annual value for the living benefit life insurance policy includes an annual value for an accumulation value, a surrender value, and a death benefit value.

The graphic representation may further include demographic information related to a person includes the person's age, an age at which distributions begin, the person's pre-retirement tax rate, the person's post-retirement tax rate, an annual rate of return for each investment, any fees associated with each investment, any premature distribution penalties associated with each investment, any sales charges associated with each investment, a capital gains tax rate, an annual contribution amount, and an annual withdrawal amount.

An advantage of the Financial Instruments Comparison system is that it compares pre-tax and after-tax instruments.

Another advantage of the Financial Instruments Comparison system is that it compares instruments in one equitable report.

A further advantage of the Financial Instruments Comparison system is that it allows for easy comparisons.

Yet another advantage of the Financial Instruments Comparison system is that it provides for an accurate analysis of the investor's options.

Another advantage of the Financial Instruments Comparison system is that it leads to more sales for insurance professionals.

Additional objects, advantages and novel features of the examples will be set forth in part in the description which follows, and in part will become apparent to those skilled in the art upon examination of the following description and the accompanying drawings or may be learned by production or operation of the examples. The objects and advantages of the concepts may be realized and attained by means of the methodologies, instrumentalities and combinations particularly pointed out in the appended claims.

### BRIEF DESCRIPTION OF THE DRAWINGS

The drawing figures depict one or more implementations in accord with the present concepts, by way of example only, not by way of limitations. In the figures, like reference numerals refer to the same or similar elements.

FIG. 1 is a block diagram of a Financial Instruments Comparison system including a controller, database, and user interface with the context within which it may be used.

FIG. 2 is a flow chart illustrating a method of calculating and comparing the different financial instruments.

FIGS. 3A-3D is a sample report generated by the Financial Instruments Comparison system.

FIG. 4 is a graphical report generated by the Financial Instruments Comparison system.

FIG. 5 is another graphical report generated by the Financial Instruments Comparison system.

### DETAILED DESCRIPTION OF THE INVENTION

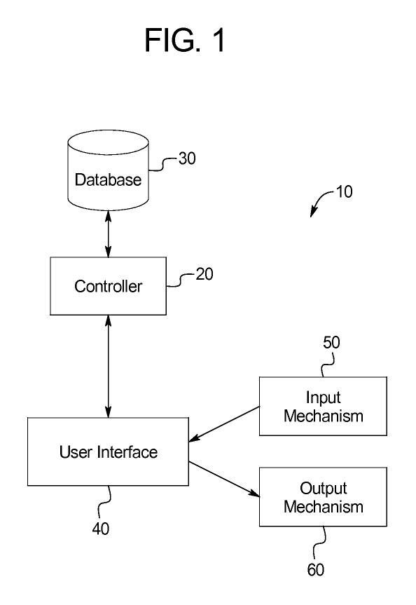

FIG. 1 illustrates an example of a Financial Instruments Comparison system 10. The Financial Instruments Comparison system 10 shown in FIG. 1 includes a controller 20 associated with a database 30. The purpose of the database 30 is to facilitate the storage and retrieval of information within the Financial Instruments Comparison system 10, though it is understood that certain embodiments of the invention may not include the database 30 and that the information storage and retrieval may be accomplished in other manners, including through the implementation of the software itself

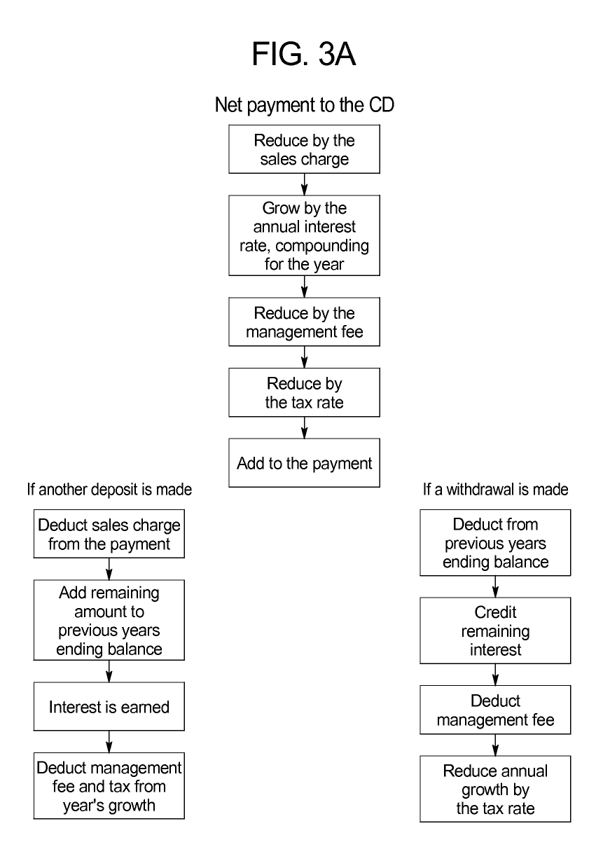

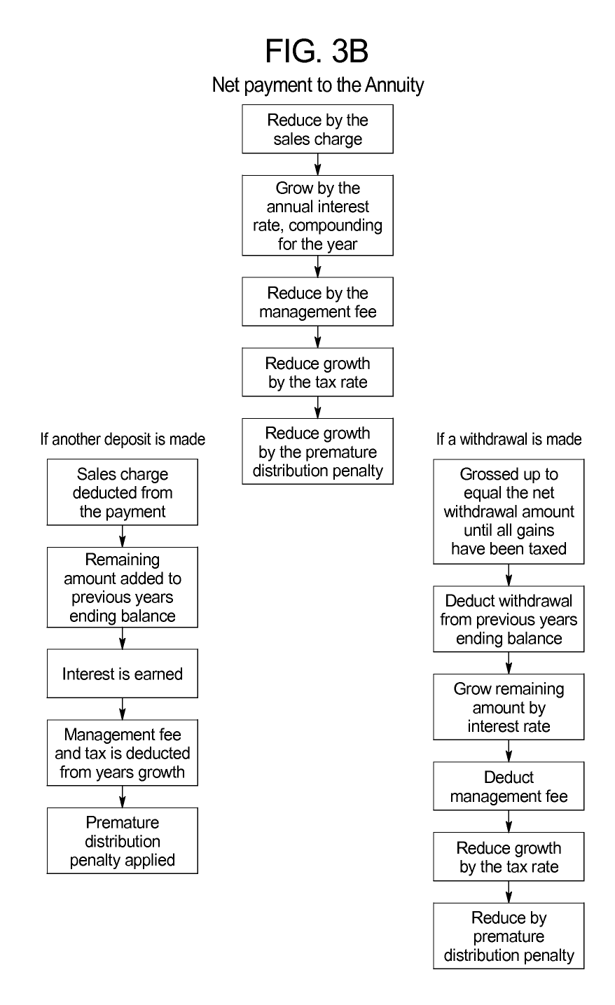

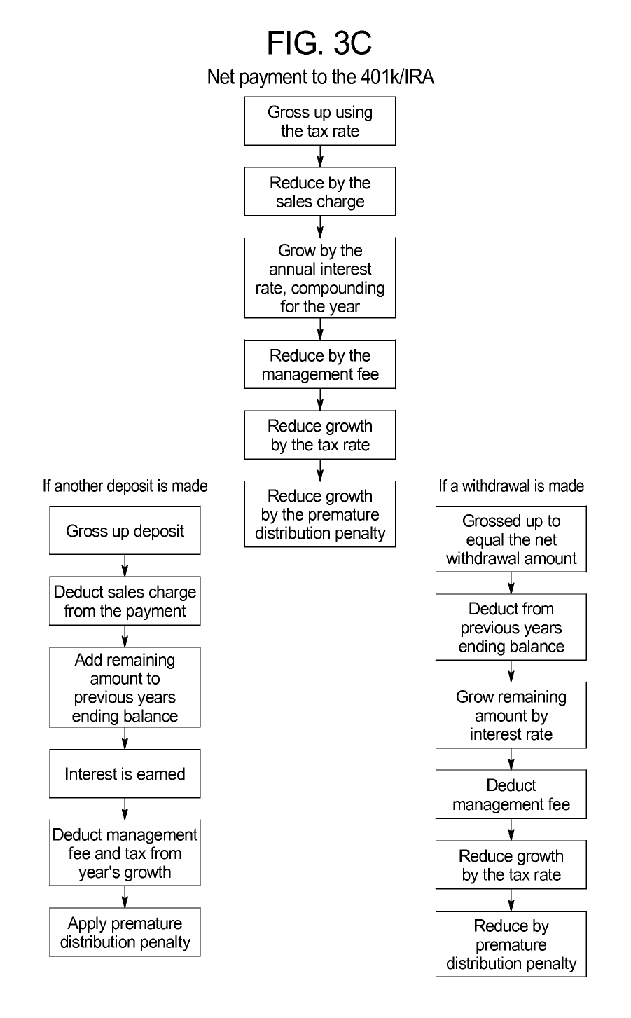

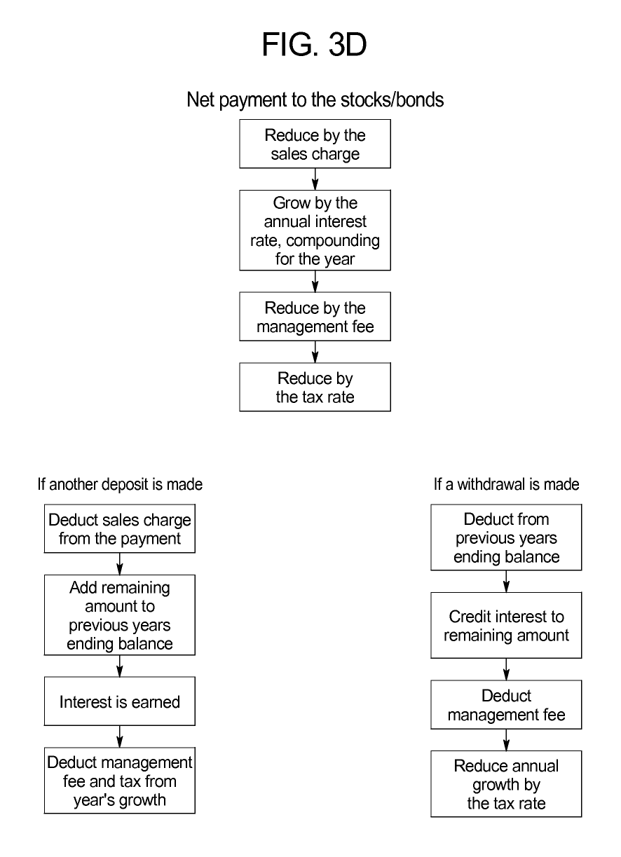

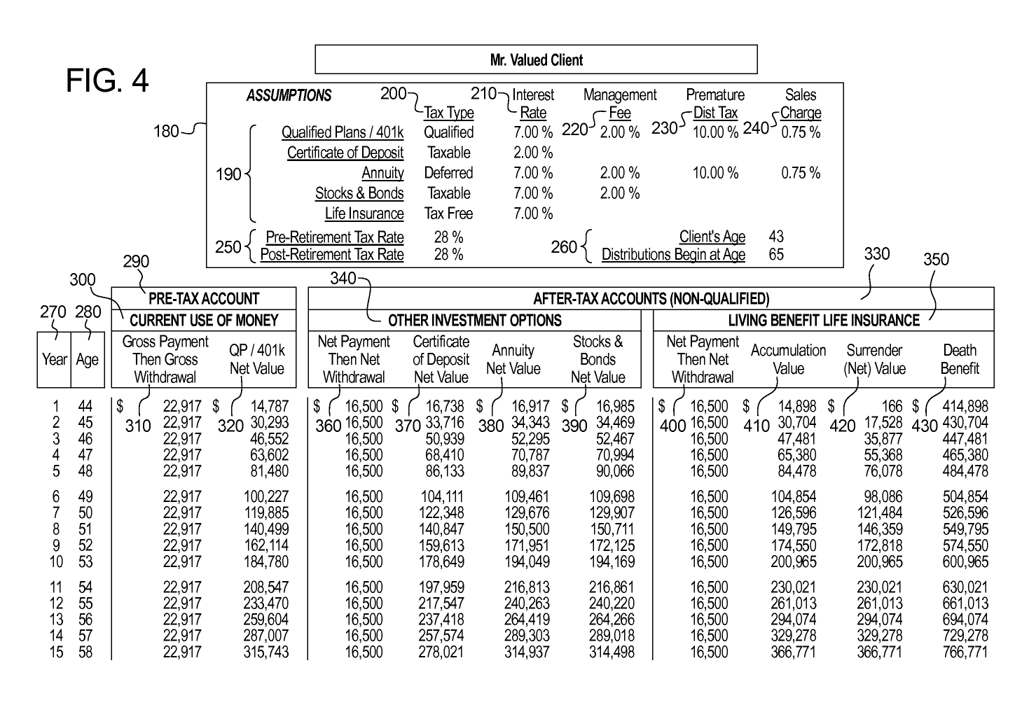

As shown in FIG. 1, the controller 20 may send information to and receive information from a user interface 40. The user interface 40 allows a user access to and control of the Financial Instruments Comparison system 10. As further shown, the user interface 40 includes an input mechanism 50 and output mechanism 60. Specifically, the input mechanism 50 allows a user to input various types of information used by the Financial Instruments Comparison system 10. The output mechanism 60 enables the Financial Instruments Comparison system 10 to produce results in the forms of reports and charts, as is further discussed with respect to FIG. 3 and FIG. 4.

It is understood that the controller 20, user interface 40, input mechanism 50 and output mechanism 60 may be provided in many forms, including that of a personal computer (desktop, laptop, tablet, etc.), a smartphone (whether through a web browser or specific application), or other device as will be recognized by one having ordinary skill in the art.

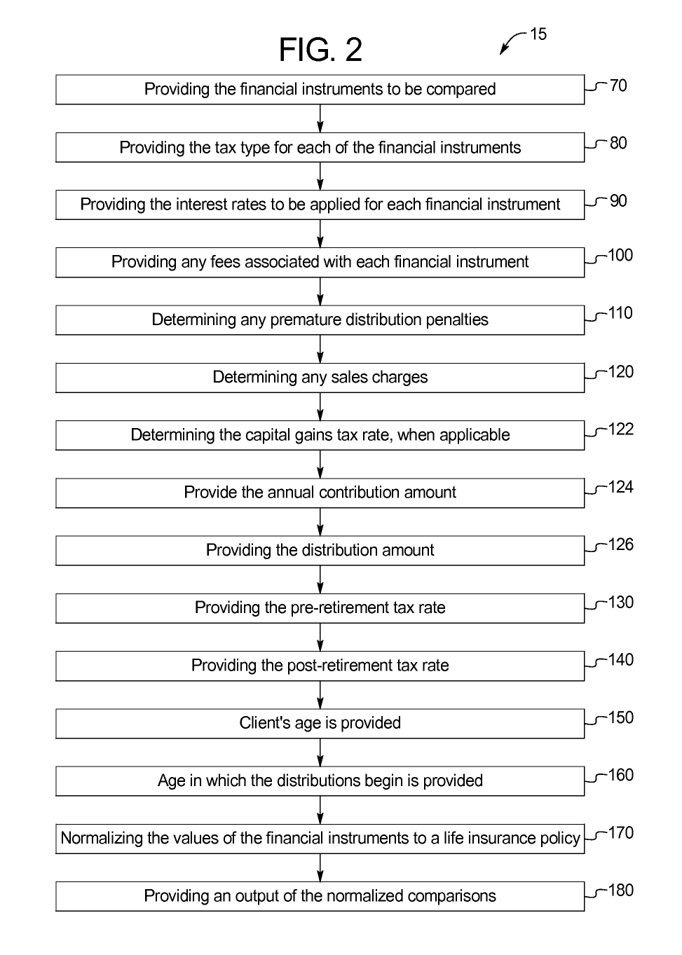

The Financial Instruments Comparison system 10 may be adapted to receive, as inputs, demographic information related to a person and investment information related to a life insurance policy, one or more qualified plans and one or more common financial instruments and provide, as an output, a normalized comparison of the life insurance, qualified plans and other common financial instruments based on the person's demographic information, as described further herein with reference to FIG. 2.

Turning now to FIG. 2, an example of a method 15 of using the Financial Instruments Comparison system 10 is shown. As shown in FIG. 2, the first step 70 includes providing the financial instruments to be compared. In the example provided, the financial instruments to be compared are Qualified Plans/401K, Certificate of Deposit, Annuity, Stocks and Bonds, and Life Insurance. The second step 80 includes providing the tax type of each of the financial instruments to be compared. The third step 90 includes providing the interest rates to be applied for each of the different financial instruments. The fourth step 100 includes providing any management fees that may be associated with the different financial instruments. The next step 110 includes determining whether any of the financial instruments have any premature distribution penalties, and providing those penalties. The following step 120 includes determining whether the financial instruments have any sales charge, and what the particular sales charge is for each financial instrument. Further as shown in FIG. 2, the method 15 includes the step 122 of determining the capital gains tax rate, when applicable, providing the annual contribution amount in step 124 and providing the amount of the distribution in step 126.

After those values are noted for each financial instrument, there are some general values that are collected. In the next step 130, the user's pre-retirement tax rate is noted (the user or other person for whom the comparisons are being made), and then in the following step 140, the post-retirement tax rate is noted. Then in the next step 150, the user's age is provided, and in the following step 160 the age in which the distributions begin is provided. All of these values that are collected are essential in order for the Financial Instruments Comparison system 10 to be effective.

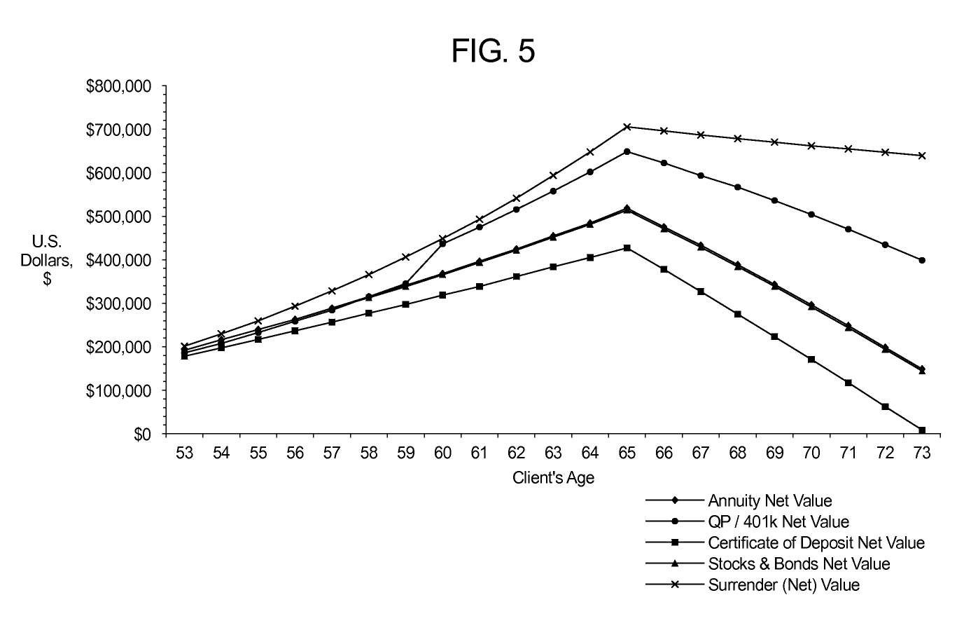

The next step 170 includes normalizing the values of the financial instruments for comparison to a life insurance policy. The final step 180 includes providing an output of the normalized comparisons to the life insurance policy. Specific examples of the steps required for normalizing each type of financial instrument are provided in FIG. 3. In addition, examples of the normalized outputs are provided in FIG. 4 and FIG. 5.

As used herein, reference to FIG. 3 generally refers to each of FIGS. 3A, 3B, 3C and 3D cumulatively. FIG. 3 provides the steps for normalizing each of the financial instruments to be compared to the life insurance policy, namely a certificate of deposit, an annuity, a 401k/IRA, and a stocks/bonds account.

As shown, FIG. 3A provides the steps for normalizing a certificate of deposit (CD) to the life insurance policy to be compared. In order to normalize a certificate of deposit to a life insurance policy, the net payment into the CD needs to be reduced by the sales charge, then grown by the annual interest rate, compounding for the year. Any net payment is then reduced by the management fee, the growth is reduced by the tax rate and then added to the payment. In years two on, if another deposit is made, the sales charge needs to be deducted from the payment. The remaining amount needs to be added to the previous years ending balance, then interest is earned, the management fee is deducted and the tax is deducted from that year's growth. If a withdrawal is made, it is first deducted from the previous years ending balance, then interest is credited on the remaining amount, then the management fee is deducted, and the year's growth is reduced by the tax rate. The process provided and described with respect to FIG. 3A produces a normalized value for a certificate of deposit that can be directly compared to the life insurance policy.

As shown in FIG. 3B a process for normalizing an annuity to a life insurance policy is provided. As provided, for an annuity, a net payment to the annuity needs to be first reduced by the sales charge, then grown by the interest rate, compounding for the year. Then the payment is reduced by the management fee and finally any growth is reduced both by the tax rate and the premature distribution penalty. In years two on, if another deposit is made, the sales charge is deducted from the payment, and the remaining amount is added to the previous year's ending balance. Then interest is earned, the management fee is deducted, the tax rate is deducted from that year's growth and the premature distribution penalty is applied to the entire amount. If a withdrawal is made, it is grossed up to equal the net withdrawal amount until all gains have been taxed, and then deducted from the previous years ending balance. Then the remaining amount is grown by the interest rate, the management fee is deducted, the growth is reduced by the tax rate, and finally the balance of the account is reduced by the premature distribution penalty. The early distribution penalty does not apply to ages 60 on. This process produces a normalized value for an annuity that can be directly compared to the life insurance policy.

As shown, FIG. 3C provides the steps for normalizing a net payment to a 401(k) or IRA to the life insurance policy to be compared. As shown in FIG. 3C, a net payment to the 401k/IRA needs to be grossed up using the tax rate, reduced by the sales charge, and then grown by the interest rate (assumed rate of return), compounding for the year. The payment is then reduced by the management fee, and then finally the growth needs to be reduced by the tax rate and the premature distribution penalty. An example of grossing up a net payment is if the net payment is $1,000 in the 30% tax bracket, it would gross up to a $1,429 deposit. In years two on, if another deposit is made, it is grossed up, the sales charge is deducted from the payment, the remaining amount is added to the previous years ending balance, and then interest is earned. Then the management fee is deducted, the tax rate is deducted from that year's growth, and the premature distribution penalty is applied to the entire amount. If a withdrawal is made, it is grossed up off of the withdrawal amount, and then it is deducted from the previous years ending balance. Then the remaining amount is grown by the interest rate, the management fee is deducted, and the balance is reduced by the tax rate and the premature distribution penalty. The early distribution penalty does not apply to ages 60 on. This process produces a normalized value for a 401k/IRA that can be directly compared to the life insurance policy.

As shown, FIG. 3D provides the steps for normalizing a stocks and bonds account to a life insurance policy. As shown, a net payment to the stock/bond account is reduced by the sales charge and grown by the interest rate, compounding for the year. The payment is then reduced by the management fee and the growth is reduced by the tax rate. In years two on; if another deposit is made, then the sales charge needs to be deducted from the payment, the remaining amount needs to be added to the previous years ending balance, and then interest is earned. Then the management fee and tax is deducted from that year's growth. If a withdrawal is made, it is deducted from the previous years ending balance, the remaining amount is credited interest, the management fee is deducted, and then finally that year's growth is reduced by the tax rate. This process produces a normalized value for a stocks/bonds account that can be directly compared to the life insurance policy.

FIG. 4 illustrates an example of a report generated and output by the Financial Instruments Comparison system 10. As shown in FIG. 4, an assumptions box 180 provides a detailed listing of the assumptions provided to the Financial Instruments Comparison system 10. The assumptions box 180 contains a unique format of input information designed to help a consumer understand the different investment options that are compared in the remaining portion of the outputs chart.

Within the assumptions box 180, the first column 190 identifies the different financial instruments that are used for comparison. In the example shown in FIG. 4, the first column includes Qualified Plans/401K, Certificate of Deposit, Annuity, Stocks and Bonds, and Life Insurance. Each of the financial instruments listed is associated with a given value for tax type, interest rate, management fee, premature distribution tax, and sales charge.

The second column 200 shown in the assumptions box provides the tax type for each financial instrument listed in the first column 190. In the example shown in FIG. 4, the financial instruments are identified by tax types including qualified, taxable, deferred, and tax free. The third column 210 provides the interest rates (or assumed rate of return) for each of the financial instruments. In the example shown in FIG. 4, the interest rates are represented by an annual growth percentage. The fourth column 220 provides the management fees related to each of the financial instruments. Not all of the financial instruments may have a management fee, and if they do not, the corresponding space is left blank. The fifth column 230 contains the premature distribution tax rate for each of the financial instruments. As explained above, not all of the financial instruments may have a premature distribution tax, and if they do not, the corresponding space is left blank. The sixth column 240 contains the sales charge for each of the financial instruments. Once again, not all of the financial instruments may have a sales charge, and if they do not, the corresponding space is left blank.

As shown, the arrangement of the financial instruments in the upper portion of the assumptions box 180 is an organized and unique layout allowing the user to easily observe the characteristics of the different instruments to be compared. Shown beneath those values, are four other essential pieces of information.

In the lower potions of the assumptions box 180 shown in FIG. 4, underneath the first column 190 of different financial instruments, is a small column 250 that displays both the pre-retirement tax rate, and the post-retirement tax rate. To the right of column 250 is another column 260 that contains the client's age and the age in which the distributions begin for that particular client. Accordingly, the assumptions box 180 provides a user all of the information related to the system assumptions in an easily digestible, organized, logical format.

As further shown in FIG. 4, a distinctive layout of normalized comparison results is provided beneath the assumptions box 180. The results are organized according to the first few columns. The first column 270 is the year, starting at year one, and increasing in one-year increments. The second column 280 is the age of the client, increasing in one-year increments. The results of the Financial Instruments Comparison system 10 may go on for any desired number of years. Each additional number of years would create a new row, containing unique results.

The results of the normalized comparison of the Financial Instruments Comparison system 10 are arranged in two main sections. The first main section 290 is titled Pre-Tax Account. The first main section also contains a sub-section 300 titled Current Use of Money. This sub-section 300 is then broken up into two smaller columns. The first column 310 is labeled Gross Payment Then Gross Withdrawal, and the second column 320 is labeled Qualified Plan/401K Net Value. Underneath each small column are the values of the corresponding uses of money in dollars.

The second main section 330 of results is titled After-Tax Accounts (Non-Qualified). This second main section 330 contains two sub-sections. The first sub-section 340 is titled Other Investment Options, and the second sub-section 350 is titled Living Benefit Life Insurance. The first sub-section 340 is broken up into four smaller columns. The first column 360 is labeled Net Payment Then Net Withdrawal, the second column 370 is labeled Certificate of Deposit Net Value, the third column 380 is labeled Annuity Net Value, and the fourth column 390 is labeled Stocks and Bonds Net Value. Underneath each column are the values of the corresponding investment options in dollars.

The second sub-section 350 titled Living Benefit Life Insurance is broken up into three smaller columns. The first column 360 is labeled Net Payment Then Net Withdrawal, the second column 410 is labeled Accumulation Value, the third column 420 is labeled Surrender (Net) Value, and the fourth column 430 is labeled Death Benefit. Underneath each column are the values of the corresponding living benefit life insurance options in dollars.

The main purpose of the results chart generated by the Financial Instruments Comparison system 10 shown in FIG. 4 is to display the output data in a way that can be easily understood and useful to an insurance consumer, so that they can choose an investment option suitable to their needs. However, it is contemplated that in other embodiments the Financial Instruments Comparison system 10 may provide different results charts or they may be organized in different ways, or include different options and/or columns.

Turning now to FIG. 5, the results from FIG. 4 are organized into a graphical representation. In the example shown in FIG. 5, the amount of dollars is shown as client's age increases over time. In this example, there are four different investment options that are being compared to the living benefit life insurance. The investment options shown in FIG. 5 include annuity net value, qualified plan/401k net value, certificate of deposit net value, and stocks and bonds net value. Each investment option is color coded, thus allowing the consumer to easily compare and contrast his/her different options. It is contemplated that in other embodiments, the investment options may be shown in any other graphical configuration that can be easily understood by the consumer.

It should be noted that various changes and modifications to the presently preferred embodiments described herein will be apparent to those skilled in the art. Such changes and modifications may be made without departing from the spirit and scope of the present invention and without diminishing its attendant advantages.

I claim:

1. A method of providing a comparison of investments financial instruments comprising the steps of:
receiving, as an input, demographic information related to a person;
receiving, as an input, information related to a life insurance policy;
receiving, as an input, information related to one or more qualified plans;
receiving, as an input, information related to one or more non-qualified investments; and
providing, as an output, a graphic representation of a comparison of the value of the life insurance policy, the one or more qualified plans and the one or more non-qualified investments, wherein the graphic representation includes normalized values for the value of the life insurance policy, the one or more qualified plans, and the one or more non-qualified investments.

2. The method of claim 1 wherein the life insurance policy is a living benefit life insurance policy.

3. The method of claim 2 wherein the demographic information related to a person includes the person's age, an age at which distributions begin, the person's pre-retirement tax rate, the person's post-retirement tax rate, an annual rate of return for each investment, any fees associated with each investment, any premature distribution penalties associated with each investment, any sales charges associated with each investment, a capital gains tax rate, an annual contribution amount, and an annual withdrawal amount.

4. The method of claim 3 wherein the normalized value of the one or more qualified plans and the normalized value of the one or more non-qualified investments are normalized for comparison to the living benefit life insurance policy.

5. The method of claim 4 wherein the one or more non-qualified investments includes a certificate of deposit, wherein the normalized value of the certificate of deposit is determined as follows:
in years in which a contribution is made:
adding the value of the contribution to the value of the certificate of deposit;
reducing the value of the certificate of deposit by any sales charge;
growing the value of the certificate of deposit by the interest rate;
reducing the value of the certificate of deposit by any management fee; and
reducing the value of the certificate of deposit by a tax rate;
in years in which a withdrawal is made:
subtracting the value of the withdrawal from the value of the certificate of deposit;
growing the value of the certificate of deposit by the interest rate;
reducing the value of the certificate of deposit by any management fee; and
reducing the value of the certificate of deposit by a tax rate.

6. The method of claim 4 wherein the one or more non-qualified investments includes an annuity, wherein the normalized value of the annuity is determined as follows:
in years in which a contribution is made:
reducing the value of the contribution by any sales charge;
adding the reduced value of the contribution to the value of the annuity;
growing the value of the annuity by the interest rate;
reducing the value of the annuity by any management fee;
reducing the value of the annuity by a tax rate; and
reducing the value of the annuity by any premature distribution penalty that applies;
in years in which a withdrawal is made:
subtracting a gross withdrawal value from the value of the annuity, wherein the gross withdrawal value is the gross value required to make a given net withdrawal;
growing the value of the annuity by the interest rate;
reducing the value of the annuity by any management fee; and
reducing the value of the annuity by a tax rate; and
reducing the value of the annuity by any premature distribution penalty that applies.

7. The method of claim 4 wherein the one or more non-qualified investments includes a stock or bond investment, wherein the normalized value of the stock or bond investment is determined as follows:
in years in which a contribution is made:
reducing the value of the contribution by any sales charge;
adding the reduced value of the contribution to the value of the stock or bond investment;
growing the value of the stock or bond investment by the interest rate;
reducing the value of the stock or bond investment by any management fee; and
reducing the value of the stock or bond investment by a tax rate;
in years in which a withdrawal is made:
subtracting the withdrawal from the value of the stock or bond investment;
growing the value of the stock or bond investment by the interest rate;
reducing the value of the stock or bond investment by any management fee; and
reducing the value of the stock or bond investment by a tax rate.

8. The method of claim 4 wherein the one or more qualified investments includes an 401k or IRA investment, wherein the normalized value of the 401k or IRA investment is determined as follows:
in years in which a contribution is made:
adding a gross contribution value to the value of the 401k or IRA investment, wherein the gross contribution value is the gross value required to equal a non-qualified contribution;
reducing the value of the 401k or IRA investment by any sales charge;
growing the value of the 401k or IRA investment by the interest rate;
reducing the value of the 401k or IRA investment by any management fee;
reducing the value of the 401k or IRA investment by a tax rate; and
reducing the value of the 401k or IRA investment by any premature distribution penalty that applies;
in years in which a withdrawal is made:
subtracting a gross withdrawal value from the value of the 401k or IRA investment, wherein the gross withdrawal value is the gross value required to make a given net withdrawal;
growing the value of the 401k or IRA investment by the interest rate;
reducing the value of the 401k or IRA investment by any management fee; and
reducing the value of the 401k or IRA investment by a tax rate; and
reducing the value of the 401k or IRA investment by any premature distribution penalty that applies.

9. The method of claim 4 wherein the graphic representation includes an accumulation value, a surrender value, and a death benefit value for the living benefit life insurance.

10. A graphic representation of a comparison between investments in a plurality of financial instruments comprising:
an annual normalized value for each of a life insurance policy, one or more qualified investments, and one or more non-qualified investments, wherein the life insurance policy is a living benefit life insurance policy, wherein the annual value for each of the one or more qualified investments and one or more non-qualified investments are normalized to compare with the living benefit life insurance policy, further wherein the annual value for the living benefit life insurance policy includes an annual value for an accumulation value, a surrender value, and a death benefit value.

11. The graphic representation of claim 10 wherein the normalized value of the one or more non-qualified investments includes a normalized value of a certificate of deposit, wherein the normalized value of the certificate of deposit is determined as follows:
in years in which a contribution is made:
adding the value of the contribution to the value of the certificate of deposit;
reducing the value of the certificate of deposit by any sales charge;
growing the value of the certificate of deposit by the interest rate;
reducing the value of the certificate of deposit by any management fee; and
reducing the value of the certificate of deposit by a tax rate;
in years in which a withdrawal is made:
subtracting the value of the withdrawal from the value of the certificate of deposit;
growing the value of the certificate of deposit by the interest rate;
reducing the value of the certificate of deposit by any management fee; and
reducing the value of the certificate of deposit by a tax rate.

12. The graphic representation of claim 10 wherein the normalized value of the one or more non-qualified investments includes a normalized value of an annuity, wherein the normalized value of the annuity is determined as follows:
in years in which a contribution is made:
reducing the value of the contribution by any sales charge;
adding the reduced value of the contribution to the value of the annuity;
growing the value of the annuity by the interest rate;
reducing the value of the annuity by any management fee;
reducing the value of the annuity by a tax rate; and
reducing the value of the annuity by any premature distribution penalty that applies;
in years in which a withdrawal is made:
subtracting a gross withdrawal value from the value of the annuity, wherein the gross withdrawal value is the gross value required to make a given net withdrawal;
growing the value of the annuity by the interest rate;
reducing the value of the annuity by any management fee; and
reducing the value of the annuity by a tax rate; and
reducing the value of the annuity by any premature distribution penalty that applies.

13. The graphic representation of claim 10 wherein the normalized value of the one or more non-qualified investments includes a normalized value of a stock or bond investment, wherein the normalized value of the stock or bond investment is determined as follows:
in years in which a contribution is made:
reducing the value of the contribution by any sales charge;
adding the reduced value of the contribution to the value of the stock or bond investment;
growing the value of the stock or bond investment by the interest rate;
reducing the value of the stock or bond investment by any management fee; and
reducing the value of the stock or bond investment by a tax rate;
in years in which a withdrawal is made:
subtracting the withdrawal from the value of the stock or bond investment;
growing the value of the stock or bond investment by the interest rate;
reducing the value of the stock or bond investment by any management fee; and
reducing the value of the stock or bond investment by a tax rate.

14. The graphic representation of claim 10 wherein the graphic representation further includes demographic information related to a person includes the person's age, an age at which distributions begin, the person's pre-retirement tax rate, the person's post-retirement tax rate, an annual rate of return for each investment, any fees associated with each investment, any premature distribution penalties associated with each investment, any sales charges associated with each investment, a capital gains tax rate, an annual contribution amount, and an annual withdrawal amount.
